(19) United States
(12) Patent Application Publication
(10) Pub. No.: US 2019/0391815 A1
(43) Pub. Date: Dec. 26, 2019

(54) INSTRUCTION AGE MATRIX AND LOGIC FOR QUEUES IN A PROCESSOR

(71) Applicant: International Business Machines Corporation, Armonk, NY (US)

(72) Inventors: Elizabeth McGlone, Oronoco, MN (US); Marcy E. Byers, Rochester, MN (US); Robert A. Cordes, Austin, TX (US)

(21) Appl. No.: 16/014,338

(22) Filed: Jun. 21, 2018

(51) Int. Cl. G06F 9/38; G06F 9/30

(52) U.S. Cl. CPC G06F 9/3855; G06F 9/30145

(57) ABSTRACT

An information handling system and method is disclosed for processing information that in an embodiment includes at least one processor; at least one queue associated with the processor for holding instructions; and at least one age matrix associated with the queue for determining the relative age of the instructions held within the queue, including in situations where if multiple instructions enter the queue at the same time, age comparison calculations are first performed by comparing each simultaneous incoming instruction independently to instructions already in the queue, and then performing age calculations between the simultaneous incoming instructions. In one aspect, if the incoming instruction is older than any in-thread instruction already in the queue, then assigning for the older in-thread instruction in the age matrix the age of the next youngest in-thread instruction already in the queue.

### BACKGROUND

The disclosures herein relate generally to processors, and more specifically, to processors that employ queues with instruction age tracking management.

Modern information and data handling systems often execute instructions out-of-order to achieve greater processing efficiency. Because out-of-order instruction handling is common in modern information handling systems (IHS), processors typically track the age of instructions in queues e.g., issue queues, reorder queues, store queues, load queues, etc. The instruction age corresponds to the relative age that particular instruction exhibits in a queue relative to other instructions in that queue.

Many queues maintain or store a relative age from oldest through youngest for all instructions residing in or stored to the queue. The age of a particular instruction is one of multiple characteristics that a queue may maintain or store for that particular instruction. For example, a particular instruction may not issue from the queue until dependencies for that particular instruction are met. These dependencies may include, data dependencies, address dependencies, and other dependencies. A processor may select the oldest instruction to issue to an execution unit when the processor determines that dependencies for that particular instruction are met. That particular instruction may issue, for example, to an execution unit within the processor for further processing.

A queue may employ an age matrix to manage age data for each instruction within that queue. An age matrix is a matrix or array of data that determines each instructions' relative age or dispatch order relative to other instructions within that queue. A queue may update the age matrix data during the issue of any particular instruction to an execution unit, or upon any new instruction being entered or written into the queue. A queue age matrix may update latches or other memory cell data to maintain instruction age information. Updating latches within an age matrix may require latch clocking and the consumption of processor power resources. Processor power resources may be a concern to integrated circuit and processor designers.

### BRIEF SUMMARY

The summary of the disclosure is given to aid understanding of a computer system, computer architectural structure, processors, queues, age matrixes, and method of using queues and age matrixes in a processor, and not with an intent to limit the disclosure of the invention. The present disclosure is directed to a person of ordinary skill in the art. It should be understood that various aspects and features of the disclosure may advantageously be used separately in some instances, or in combination with other aspects and features of the disclosure in other instances. Accordingly, variations and modifications may be made to the computer system, the architectural structure, processors, queues, age matrixes, and their method of operation to achieve different effects. Certain aspects of the present disclosure provide a method of processing data or information in a processor, queue, and age matrix.

In one embodiment the disclosure provides a method of determining a relative age of one or more instructions in a queue in a processor. The method in an embodiment includes providing one or more incoming instructions to the queue; setting comparison entry in age matrix to a first value for the incoming instruction to the queue; setting comparison entry in an age matrix to a second value for an instruction entry containing no instruction in the queue; determining whether the incoming instruction is from a same thread as any of the one or more instructions in the queue; for an instruction in the same thread as the incoming instruction, performing an in-thread comparison and assigning the first value in the age matrix for older instructions and the second value in the age matrix for younger instructions; performing a FIFO comparison between the incoming instruction and an out of thread instruction already in the queue and assigning the first value in the age matrix for the older instruction and the second value in the age matrix for the younger instruction; and calculating values in the age matrix for queue entries to determine a relative age of instructions based upon a plurality of values entered in the age matrix. In one aspect, the first value is a binary 1 and the second value is a binary 0, and the relative age of the instructions is determined by calculating the binary values in the age matrix where the oldest instruction has the highest calculated value and the youngest instruction has the lowest calculated value in the age matrix.

In an embodiment, the age comparisons between the incoming instruction with the in-thread instructions in the queue are performed before the comparison between the incoming instruction and the out of thread instructions in the queue. For the age comparison between the incoming instruction and instructions in the queue with the same thread where the instruction is older than any instruction already in the queue, in an aspect the incoming instruction inherits the relative age comparison values for the next younger in-thread instruction for all instructions already in the queue. If multiple instructions enter the queue at the same time, performing age calculations by comparing each simultaneous incoming instruction independently to instructions already in the queue, and then performing age calculations between the simultaneous incoming instructions. Performing the age calculation between the simultaneous incoming instructions entering the queue from different threads, in an aspect, includes assigning values in the age matrix that confirms the relative age of the simultaneous incoming instructions and if in response to performing an age comparison between the two simultaneous incoming instructions from different threads there is no difference in the inherited ages, one of the simultaneous incoming instructions is assigned the value in the age matrix corresponding to an older instruction.

In an embodiment, an information handling system for processing information is disclosed. The information handling system includes at least one processor; at least one queue associated with the processor having a plurality of entry positions for holding instructions; and at least one age matrix associated with the at least one queue for determining a relative age of one or more instructions held within the queue, wherein the relative age between instructions within the queue and an incoming instruction into the queue is determined by performing an in-thread comparison between the incoming instruction and any of the plurality of instructions in the queue, and thereafter performing an out of thread comparison between the incoming instruction and any of the plurality of instructions in the queue. In an aspect, the processor is designed and configured to determine if the incoming instruction is older than any in-thread instruction already in the queue, and if the incoming instruction is older than any in-thread instruction already in the queue, then the processor is designed and configured to assign in the age matrix calculations for the older in-thread instruction, the age of the next youngest in-thread instruction already in the queue. In another aspect, the processor is designed and configured to determine if multiple instructions are entering the queue at the same time, and if multiple instructions are entering the queue at the same time, then the processor is designed and configured to perform age comparison calculations first by comparing each simultaneous incoming instruction independently to instructions already in the queue, and then perform age calculations between the simultaneous incoming instructions.

In another embodiment an information handling system for processing information is disclosed that includes at least one processor; at least one queue associated with the processor and having a plurality of entry positions for holding instructions; at least one age matrix associated with the queue for determining a relative age of an instruction held within the queue; one or more computer readable non-transitory storage media; and programming instructions stored on the one or more computer readable non-transitory storage media for execution by the at least one processor, the programming instructions including programing instructions to determine a relative age between one or more instructions within the queue and an incoming instruction into the queue including programing instructions to perform an in-thread comparison between the incoming instruction and any one of a plurality of instructions in the queue, and thereafter perform an out of thread comparison between the incoming instruction and any one of the plurality of instructions in the queue.

### BRIEF DESCRIPTION OF THE DRAWINGS

The various aspects, features and embodiments of a computer system, computer architectural structure, processor, queue, age matrix, and their method of operation will be better understood when read in conjunction with the figures provided. Embodiments are provided in the figures for the purpose of illustrating aspects, features, and/or various embodiments of the computer system, computer architectural structure, processors, queues, age matrixes, and their method of operation, but the claims should not be limited to the precise arrangement, structures, features, aspects, assemblies, systems, embodiments, or devices shown, and the arrangements, structures, subassemblies, features, aspects, methods, processes, embodiments, and devices shown may be used singularly or in combination with other arrangements, structures, assemblies, subassemblies, systems, features, aspects, embodiments, methods and devices.

FIG. 1 is block diagram of an information handling system (IHS) that includes a processor with one or more queues, e.g., issue queue, reorder queue, load queue, store queue, and an embodiment of instruction age tracking methodology.

FIG. 2 is a block diagram showing more detail of the processor that employs queues with instruction age tracking methodology.

FIG. 3 is a block diagram of a processor having multiple execution slices.

FIG. 4 is a block diagram depicting an issue queue and/or execution unit having a queue and an age matrix that employs an embodiment of an instruction age tracking methodology.

FIG. 5 is a block diagram of the queue and age matrix of FIG. 4 in accordance with an embodiment of the invention completed for an example of instructions written to the queue.

FIG. 6 is a block diagram depicting an instruction queue for a super slice of instructions and an age matrix that employs an embodiment of instruction age tracking methodology.

FIG. 7 is a block diagram of the instruction queue and age matrix of FIG. 5 completed for an example of instructions written to the queue.

FIG. 8 is a flowchart that shows process flow in the processor of FIG. 2 as it employs an embodiment of queue instruction age tracking methodology.

FIG. 9 is a flowchart that shows process flow for an embodiment of a queue instruction age tracking methodology.

### DETAILED DESCRIPTION

The following description is made for illustrating the general principles of the invention and is not meant to limit the inventive concepts claimed herein. In the following detailed description, numerous details are set forth in order to provide an understanding of the computer system, computer architectural structure, processor, queues, associated age matrix, and their method of operation, however, it will be understood by those skilled in the art that different and numerous embodiments of the computer system, computer architectural structure, processor, queues, associated age matrix, and their method of operation may be practiced without those specific details, and the claims and invention should not be limited to the embodiments, subassemblies, features, processes, methods, aspects, features or details specifically described and shown herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following discussion omits or only briefly describes conventional features of information processing systems (IHS), including processors and microprocessor systems and architectures, which are apparent to those skilled in the art. It is assumed that those skilled in the art are familiar with the general architecture of processors, and in particular with processors which operate in an out-of-order execution fashion, including multi-slice processors and their use of queues to hold instructions. It may be noted that a numbered element is numbered according to the figure in which the element is introduced, and is typically referred to by that number throughout succeeding figures.

One embodiment of the disclosed information handling system (IHS) employs a processor that includes a queue for holding instructions, and/or data, operands and information. In computer systems, there are often queue structures that need to hold multiple instructions at a time. The queue in an embodiment may be an issue queue (IQ) and may employ an age matrix to determine and manage the relative age of each instruction within the IQ. The queue in an embodiment may be a reorder queue, a load and/or store queue in, for example, a load store unit (LSU), or other queue for holding instructions, and/or data, information and operands. Sometimes, it is important to know the relative age of each instruction in a queue structure. Knowing the relative age of instructions in the queue may be used to help improve performance of a processor, and may help to decide which instruction should be executed next.

Processors currently used in information handling systems today may be capable of “superscalar” operation and may be “pipelined” elements. Such processors typically have multiple elements that operate in parallel to process multiple instructions in a single processing cycle. Pipelining involves processing instructions in stages, so that the pipelined stages may process a number of instructions concurrently. As such, the instructions do not enter the queue in age order, so younger and older instructions are jumbled together. In addition, each queue may hold multiple threads of instructions. For example, there can be up to four (4) threads held within each queue. The processor and queue may be designed and configured to process more or less number of threads.

In modern computer architecture, there are several ways to design a computer adapted to perform more than one instruction at a time, or at least in the same time frame. For example, such a computer may include more than one processor core (i.e., central processing unit) and each processor core may be capable of acting independently of other processor cores. This may allow for true multitasking, with each processor core processing a different instruction stream in parallel with the other processor cores of the computer. Another design to improve throughput may be to include multiple hardware threads within each processor core, with the threads sharing certain resources of the processor core. This may allow each processor core to take advantage of thread-level parallelism. To handle the multiple threads in each processor core, a processor core may have multiple execution slices. An execution slice may refer to a set of data processing circuitry or hardware units connected in series within a processor core. An execution slice may be a pipeline or pipeline-like structure. Multiple execution slices may be used as part of simultaneous multi-threading (SMT) within a processor core.

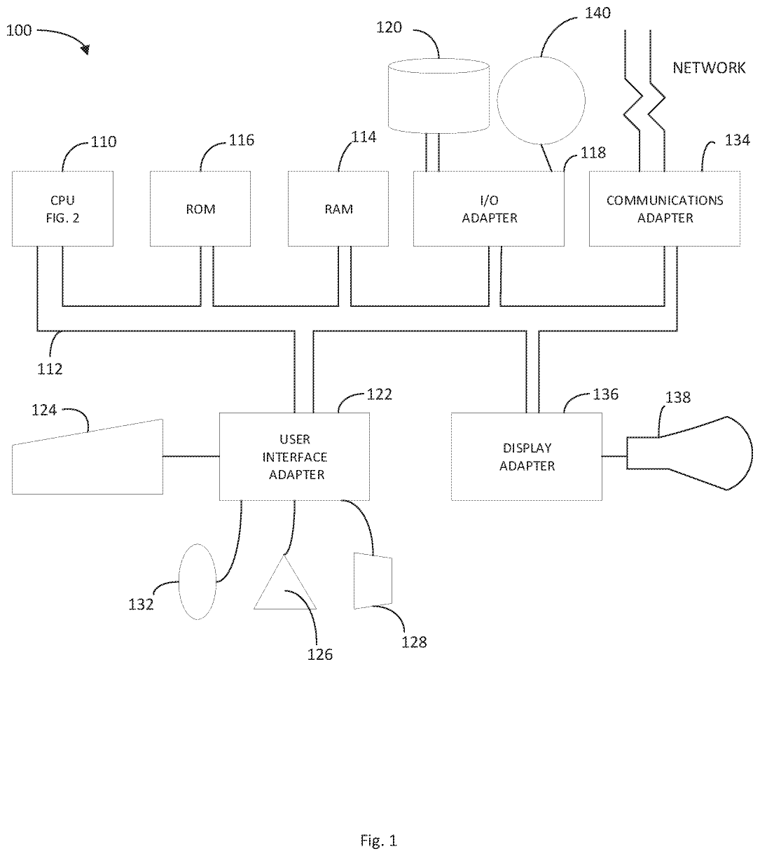

FIG. 1 illustrates an example of a data processing system 100 in which aspects of the present disclosure may be practiced. The system has a central processing unit (CPU) 110. The CPU 110 is coupled to various other components by system bus 112. Read only memory (“ROM”) 116 is coupled to the system bus 112 and includes a basic input/output system (“BIOS”) that controls certain basic functions of the data processing system 100. Random access memory (“RAM”) 114, I/O adapter 118, and communications adapter 134 are also coupled to the system bus 112. I/O adapter 118 may be a small computer system interface (“SCSI”) adapter that communicates with a disk storage device 120. Communications adapter 134 interconnects bus 112 with an outside network enabling the data processing system to communicate with other such systems. Input/Output devices are also connected to system bus 112 via user interface adapter 122 and display adapter 136. Keyboard 124, track ball 132, mouse 126 and speaker 128 are all interconnected to bus 112 via user interface adapter 122. Display monitor 138 is connected to system bus 112 by display adapter 136. In this manner, a user is capable of inputting to the system through the keyboard 124, trackball 132 or mouse 126 and receiving output from the system via speaker 128 and display 138. Additionally, an operating system such as, for example, AIX (“AIX” is a trademark of the IBM Corporation) is used to coordinate the functions of the various components shown in FIG. 1.

The CPU (or “processor”) 110 includes various registers, queues, buffers, memories, and other units formed by integrated circuitry, and may operate according to reduced instruction set computing (“RISC”) techniques. The CPU 110 processes according to processor cycles, synchronized, in some aspects, to an internal clock (not shown).

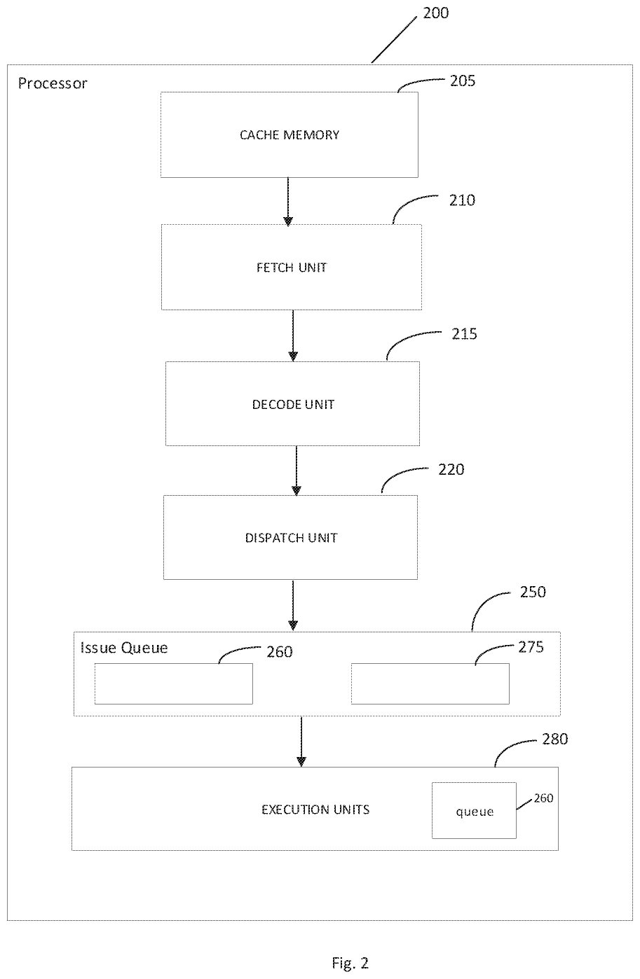

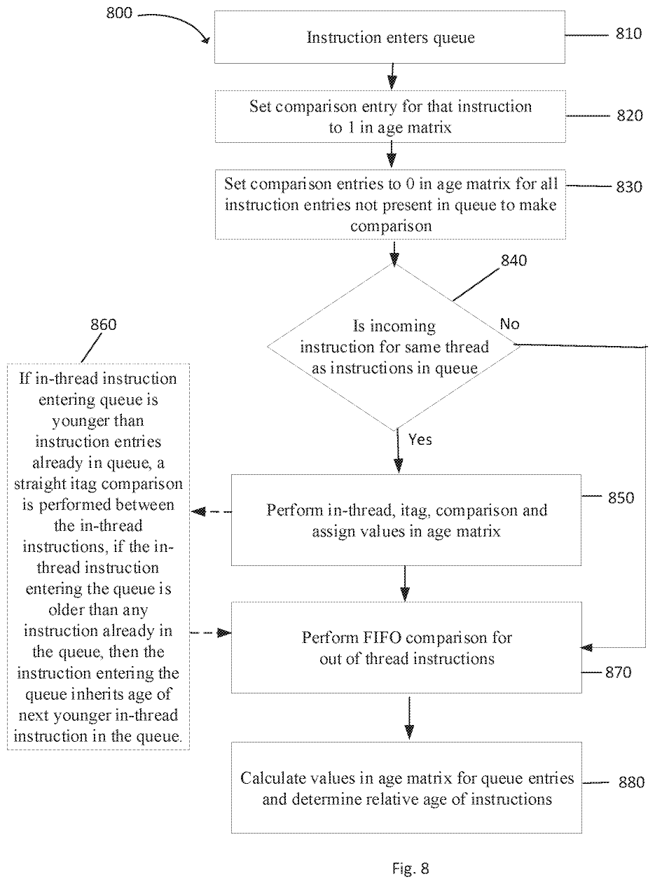

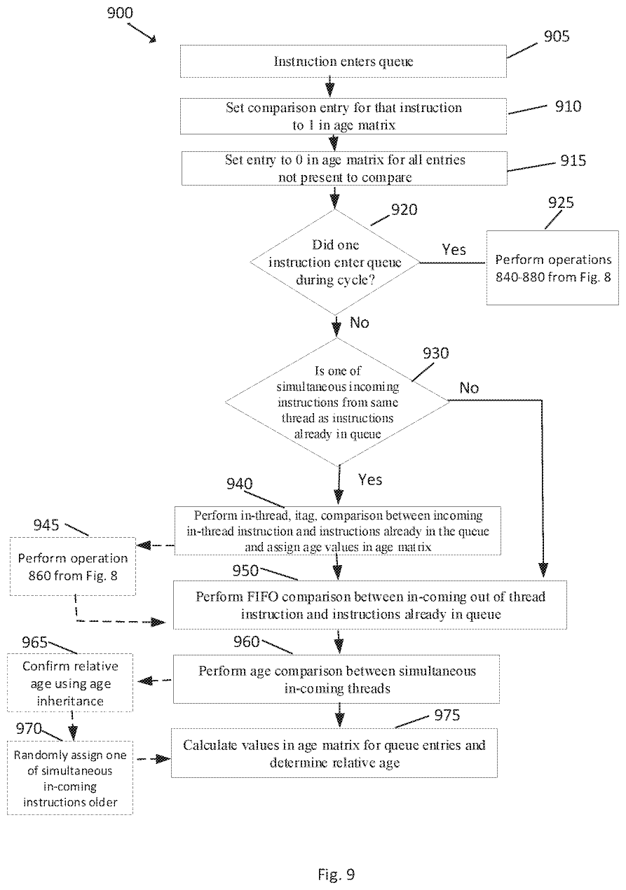

FIG. 2 shows a processor 200 that may employ the disclosed queue instruction age tracking method. In that case, processor 200 performs the functional blocks of the flowcharts of FIGS. 8-9 described below that apply to the queue instruction age tracking process and/or age matrix discussed below. Processor 200 includes a cache memory 205 that may receive processor instructions from system memory 125, non-volatile storage 140, expansion bus 165, network interface 170, or other sources not shown in FIG. 2. Cache memory 205 couples to a fetch unit 210 that processor 200 employs to fetch multiple instructions from cache memory 205. Instructions may be in the form of an instruction stream or thread that includes a series or sequence of instructions. Fetch unit 210 couples to a decode unit 215 that provides decoding of instructions as resources of processor 200 become available. Decode unit 215 couples to a dispatch unit 220. Dispatch unit 220 couples to an issue queue (IQ) 250.

In one embodiment, dispatch unit 220 dispatches one or more instructions to IQ 250 during a processor clock cycle. IQ 250 includes an instruction data store (IDS) or queue 260 that stores issue queue (IQ) instructions. For example, an issue queue that stores 24 instructions employs an IDS or queue 260 with 24 storage locations. IQ 250 includes an age matrix 275 that maintains or stores relative age data preferably for each instruction within IDS or queue 260. For example, if IQ 250 and more specifically IDS or queue 260 maintains storage locations for 24 instructions of processor 200, age matrix 275 maintains relative age data for those 24 instructions. Age matrix 275, described in more detail below, may include data (e.g., binary 1s or 0s) in a matrix (rows and columns) that corresponds to each instruction entry in IDS 260. In one embodiment, age matrix 275 includes 24 rows and 24 columns of binary storage data for 24 entries or 24 instruction stores of IDS or queue 260. In other embodiments, the queue and age matrix may contain more or less entries, and the number of entries in the queue 260 may be different than the number of entries in the age matrix 275.

IQ 250 couples to execution unit (EU) 280. EU 280 may include multiple execution units for execution of instructions from IQ 250 or instructions from other queues, such as, for example, store and/or load queues in execution units. The execution units may include load store units (LSUs), vector scalar units (VSUs), fixed point units (FXUs), floating point units (FPUs) and other execution units. Age data and the age tracking methodology, process, rules, and logic may have application to an assortment of queues, including instruction queues, reorder queues, and queues in issue queues (IQ), as well load queues and store queues in a LSU.

In one embodiment, dispatch unit 220 may dispatch multiple instructions to IQ 250 during a particular processor 200 clock cycle. For example, dispatch unit 220 may dispatch two (2) instructions at the same time, e.g. during the same processor cycle.

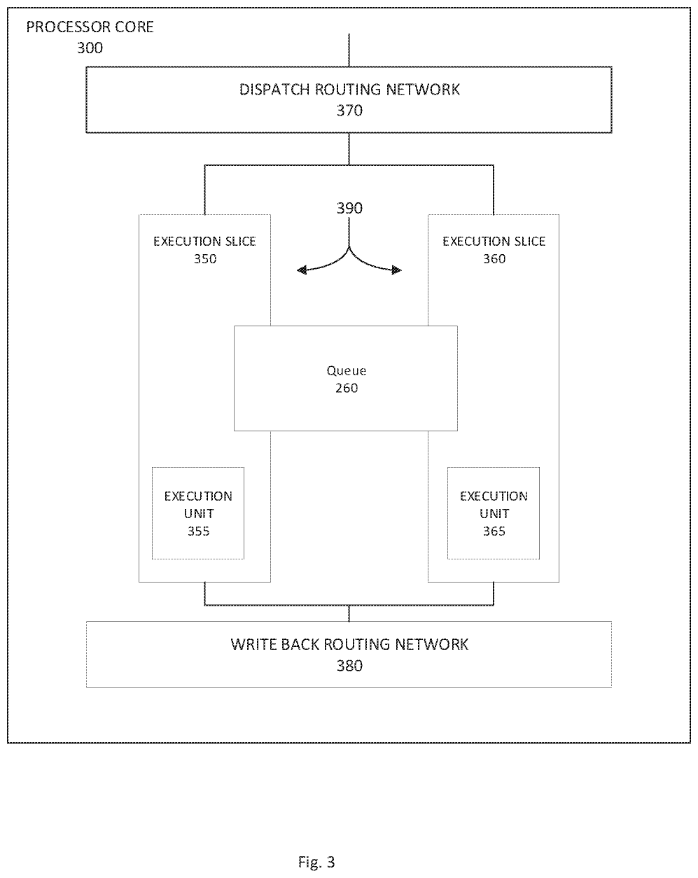

FIG. 3 shows a simplified block diagram of an exemplary processor core 300 configured with two execution slices 350 and 360. The processor core may include dispatch routing network 370, execution slices 350 and 360, and write back routing network 380. The two execution slices 350 and 360 may be grouped into a super slice 390. The processor core may include other circuits, functional units, and components. At the designated time, the dispatch routing network 370 may dispatch a given instruction to the designated instruction slice, e.g., slice 350 or slice 360. The designated execution slice 350 or 360 may then process the instruction. Once processed, the result of the instruction may be transferred through write back routing network 380 and written to registers within the register file.

The execution unit 355 may perform the operation specified by an instruction dispatched to execution slice 350. The queue 260 may serve to store instructions to be used in an operation dispatched to execution slice 350, and the result of the operation performed by execution unit 355. Similarly, the execution unit 365 may perform the operation specified by an instruction dispatched to execution slice 360. The queue 260 may serve to store instructions to be used in an operation dispatched to execution slice 360, and the result of the operation performed by execution unit 365 may be written to the designated target register in the register file.

Instructions are generally dispatched by the dispatch unit with an instruction identifier, e.g., itag, that is assigned in execution order by thread. Within one thread, by looking at the itag, selecting the oldest instruction is relatively straight forward. However, when looking across multiple threads there is no inherent age order, because the age as identified by the itag is only relative to itags within the same thread. In addition, some queues are written to by multiple instructions at the same time, i.e., during the same clock cycle. There is a need to quickly determine which instruction is the oldest in queues that handle multiple incoming instructions at the same time, with different threads and different ages. The calculation and solution need to be efficient, cost effective, such that it does not consume a lot of power, does not use a lot of processor resources, and does not increase latency.

The queue in an embodiment may employ an age matrix to determine and manage the relative age for each instruction within the queue. Each entry within the queue, in an aspect, keeps information about how old it is relative to every other entry. In one embodiment, the age matrix of the queue maintains information regarding the relative order of instruction dispatch and information regarding the sequential instruction stream order. When a new instruction is written to a particular queue entry, an initial age calculation is performed and stored, along with the instruction's other data. When necessary, the age calculation can be used to determined and select the oldest instruction in the queue.

In one embodiment, the queue employs an age matrix of N×N cells wherein N is the number of instruction entries of the queue. In other words, a queue that stores N instructions may employ an N×N matrix of binary data cells, such as latches, to represent the relative age of each instruction of the queue. In one embodiment, the age calculation row data for a particular entry of the age matrix corresponds to the age of that instruction in the queue. A queue in an aspect may update all of the data in the age matrix, including both row and column data, each time a new instruction stores or dispatches to the queue. In an embodiment, the queue may update only a portion of the data in the age matrix that changes when a new instruction stores or dispatches to the queue. A triangle of data may be stored, instead of the full age matrix (table), to save processor size and resources.

The system, processor, queue and/or age matrix employs techniques, procedures, rules, and logic to calculate the relative age of incoming instructions. The system, processor, queue and/or age matrix in an embodiment determines a thread independent age based upon its itag and the queue entrance time (FIFO). For queues that hold instructions for a single slice of a processor, there will be only one operation (instruction) entering the queue at a time. As the instruction enters the queue in the single slice mode, in an aspect, the age of the instruction is first compared against every existing instruction entry in the queue within the same thread. When all the instructions are from the same thread, an itag comparison will indicate the relative age of the instructions. At this point, and according to an aspect, no comparison is performed against any instruction entries in the queue from a different thread. In an embodiment, the incoming instruction will inherit the age of any existing younger instructions within the same thread, and in an aspect the age of the next younger instruction within the queue in the same thread. When the instructions are not from the same thread, there is no evaluation performed between the instructions from different threads, and a FIFO calculation is performed where the instruction entering the queue is considered younger than the other instructions already in the queue. These rules and logic calculations will determine an “age” order for the instruction that is valid and processable by the processor, even with instructions from different threads. An example of the age matrix calculations for instructions dispatched to a processor that only writes one instruction to the queue at a time as described below will help illustrate the procedures, rules and logic for determining the relative age of instructions in a queue. In accordance with an aspect, a full table of the age matrix is not saved, but only a triangle of information is saved as will be explained.

When a queue holds a super slice of instructions and/or where there are two simultaneous incoming instructions at the same time, e.g., in the same cycle, entering the queue, the age calculation is more complicated. The two simultaneous incoming instructions will need to both be compared to existing entries, and they both need to be compared to each other. The processes, methodology, rules, and logic for calculating relative ages of instructions in single slice queues will still apply to an extent. The process for calculating the age of two simultaneous incoming instructions in the age matrix includes determining the relative age of the two simultaneous incoming instructions individually based first upon comparison with entries already within the queue. If the incoming entries are from the same thread as an instruction in the queue, an in-thread comparison is performed to determine the relative age between the incoming instruction and the other instructions in the queue within the same thread. If the incoming instructions is older than the instruction in the queue within the same thread, the incoming instruction, in an embodiment, inherits the age of the next youngest instruction within the same thread. For instructions in the queue from different thread, a FIFO comparison is performed where the incoming instruction is deemed younger. After comparing the two simultaneous incoming instruction to instructions (entries) already in the queue, the two incoming instructions are compared to each other. If the two incoming instructions are from the same thread, an in-thread comparison is performed and the relative ages between the two instructions is determined. If the two simultaneous incoming entries are from a different thread, compare the inherited ages of the incoming instructions to each other to determine their relative ages. The incoming instruction with the oldest inherited age will need to be set and confirmed as the older instruction between the two simultaneous incoming instructions. The simultaneous incoming instruction with the inherited youngest age will be set and confirmed as the younger of the two simultaneous incoming instructions. If the two simultaneous incoming instructions have the same inherited age, one of the simultaneous incoming instructions is randomly selected and assigned as being older. For example, the incoming instruction from one of the processor slices may always be selected and set as the older instruction. The process, methodology, rules, and logic for determining the relative ages of instructions in a queue will be illustrated below with respect to examples.

Each queue or instruction data store (IDS) 260 may have an age matrix 275 associated with the queue to determine the relative age of instructions within the queue. In an embodiment, the relative age as determined and assigned as per the age matrix 275 and the processes, rules, and logic decisions in and according to the age matrix is a vector with a first value, e.g., “1”, if the entry is older than the other entry, and a second value, e.g., “0”, if the entry is younger than the other entry. This can be represented by a triangle calculation, e.g., Entry 0 is older than Entry 1; Entry 0 is older than Entry 2; Entry 0 is older than Entry 3; Entry 0 is older than Entry N, and Entry 1 is older than Entry 2; Entry 1 is older than Entry 3, Entry 1 is older than Entry N, etc., where N is the number of entries in the queue. The triangle can then be translated into a vector for each entry where the oldest entry has the most amount of first values, e.g., “F”s, and the youngest entry has the least amount of first values, e.g., “F”s, or the most amount of second values, e.g., “0”s.

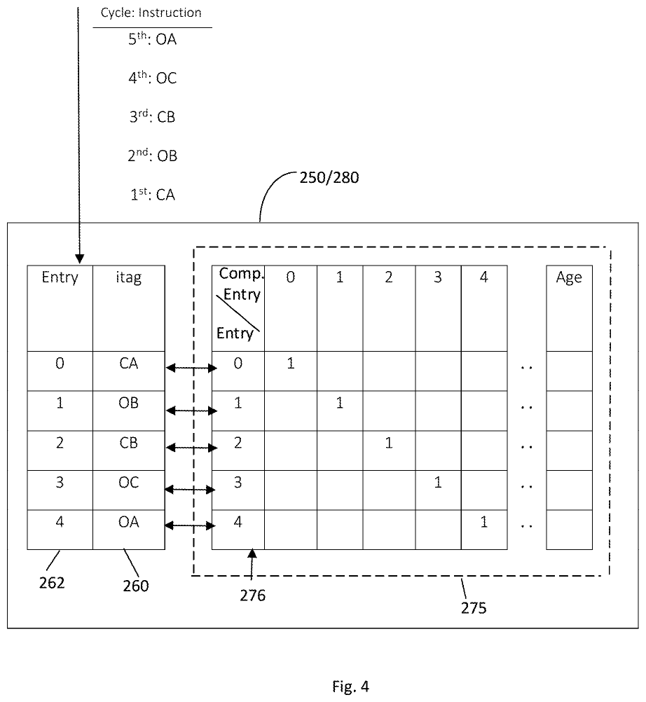

An example of instructions dispatched to queue 260 in FIG. 4 will help illustrate the, process, methodology, rules, logic and age calculations utilized and employed by age matrix 275. In FIG. 4, a set of instructions will be dispatched to queue 260. Queue 260 in FIG. 4 is a single slice queue that holds instructions from only a single slice of a processor. Queue 260 has associated with it an age matrix 275 to calculate the relative age order of the instructions written to the queue 260. In the example of FIG. 4, queue 260 has five (5) entries and age matrix likewise has five (5) entries. The entries (Entry0-Entry4) in the age matrix 275 are illustrated in FIG. 4 by column 276. Each entry in the queue 260 and age matrix 275 represents a specific instruction.

In FIG. 4, a number of instructions are dispatched to the queue 260 with an itag and placed in an entry (Entry0-Entry4) as illustrated by column 262. The itag is typically associated with the instruction by the Dispatch Unit although other circuitry or functional units might stamp the instruction with an itag. Within a thread, instructions are dispatched in chronological or execution order. The instructions in queue 260 are from multiple, different threads where in FIGS. 4-7 and Tables 1-16, instructions “CA” and “CB” are from a first thread and instructions “OA”, “OB” and “OC” are from a second, different thread. Within each thread, the oldest instructions within a thread are identified in alphabetical order such that instruction OA is older than instruction OB, and instruction OB is older than instruction OC, etc. The earlier an instruction is dispatched, the older the instruction. In the nomenclature used in the example of FIGS. 4-7 and Tables 1-16, the left place holder identifies the thread and the right place holder represents the instruction age within that thread, such that instruction “CA” for example is the first instruction “A” from the thread “C”. In the example of FIG. 4, the instructions are dispatched to the queue 260 in the following order: CA, OB, CB, OC, and OA. The instructions may be dispatched to any entry in the queue.

When instruction, e.g., itag, CA enters queue 260 there is no other instruction in the queue. Instruction or itag CA is assigned or placed in Entry 0 in queue 260. Since Entry 0 is the only entry in queue 260, there are no other entries to compare instruction CA (Entry0) and all the comparison entries in the Entry 0 row that do not have a comparison thread are set to 0 as a default as shown in Table 1 below. An entry compared to itself is always set to 1, so Table 1 shows the age matrix 275 for the first instruction CA in Entry 0.

TABLE 1

| | Comparison Entry | | | | |
|---|---|---|---|---|---|
| Entry | 0 | 1 | 2 | 3 | 4 |
| 0: CA | 1 | 0 | 0 | 0 | 0 |
| 1 | | | | | |
| 2 | | | | | |
| 3 | | | | | |
| 4 | | | | | |

The next instruction OB enters the queue into Entry 1. When the next instruction OB (Entry 1) enters queue 260, it is from a different thread than instruction CA. Accordingly, no itag compare is performed because the two entries in the queue are from different threads. As such, in an embodiment, a FIFO evaluation is performed and since instruction OB came into queue 260 after instruction CA, instruction CA (Entry0) is considered older than instruction OB (Entry 1) and so Entry 0_older_Entry 1=1, and Entry1_younger_Entry 0=0, which is shown in Table 2 below. In other words, since location 0:1 (row: column) represents a comparison of Entry 0 to Entry 1 and Entry 0 is older, location 0:1 gets set to 1, and since location 1:0 (row:column) represents a comparison of Entry 1 to Entry 0 and Entry 1 is younger, location 1:0 gets set to 0.

TABLE 2

| | Comparison Entry | | | | |
|---|---|---|---|---|---|
| Entry | 0 | 1 | 2 | 3 | 4 |
| 0: CA | 1 | 1 | 0 | 0 | 0 |
| 1: OB | 0 | 1 | | | |
| 2 | | | | | |
| 3 | | | | | |
| 4 | | | | | |

Since there are only two instructions that have dispatched to the queue, there are no other instructions to compare in queue 260 and the remaining comparison entries for Entry 1 are set to 0 as shown in Table 3.

TABLE 3

| | Comparison Entry | | | | | Age |
|---|---|---|---|---|---|---|
| Entry | 0 | 1 | 2 | 3 | 4 | Cal |
| 0: CA | 1 | 1 | 0 | 0 | 0 | 2 |
| 1: OB | 0 | 1 | 0 | 0 | 0 | 1 |
| 2 | | | | | | |
| 3 | | | | | | |
| 4 | | | | | | |

| Oldest | | Youngest |
|---|---|---|
| | CA | OB |

The next instruction CB enters the queue into Entry 2. When the next instruction CB (Entry 2) enters the queue, it is from the same thread as CA and a different thread then OB. An in-thread comparison is performed first, so an itag comparison is performed between instruction CA (Entry 0) and instruction CB (Entry 2). Instruction CB (Entry 2) is younger that instruction CA (Entry 0), so instruction CB will not inherit the age of instruction CA, and based upon an itag comparison, Entry 0 (instruction CA) is older than Entry 2 (instruction CB) so Entry 0 compared to Entry 2 is set to 1 (Entry0_older_Entry2=1) as shown in Table 4 below. That is, location 0:2 (row: column) in age matrix 275 (and Table 4) is set to 1, and Entry 2 (instruction CB) is younger than Entry 0 (instruction CA) so Entry 2 compared to Entry 0 is set to 0 (Entry2_younger_Entry0=0) as shown in Table 4 (location 2:0=0).

TABLE 4

| | Comparison Entry | | | | |
|---|---|---|---|---|---|
| Entry | 0 | 1 | 2 | 3 | 4 |
| 0: CA | 1 | 1 | 1 | 0 | 0 |
| 1: OB | 0 | 1 | | 0 | 0 |
| 2: CB | 0 | | 1 | | |
| 3 | | | | | |
| 4 | | | | | |

Since we cannot do an itag comparison between instruction CB (Entry 2) and instruction OB (Entry 1), a FIFO comparison is performed and since Entry 2 (instruction CB) came in after instruction OB (Entry 1), instruction CB (Entry 2) is younger and we set Entry 2 younger_Entry1=0 (location 2:1=0) and Entry1_older_Entry2=1 (location 1:2=1) as shown in Table 5. The remaining comparison entries for instruction CB (Entry 2) corresponding to Entry locations 3 and 4 are set to 0 since there are no instructions in Entry locations 3 and 4 for comparison.

TABLE 5

| | Comparison Entry | | | | | Age |
|---|---|---|---|---|---|---|
| Entry | 0 | 1 | 2 | 3 | 4 | Cal |
| 0: CA | 1 | 1 | 1 | 0 | 0 | 3 |
| 1: OB | 0 | 1 | 1 | 0 | 0 | 2 |
| 2: CB | 0 | 0 | 1 | 0 | 0 | 1 |
| 3 | | | | | | |
| 4 | | | | | | |

| Oldest | | | Youngest |
|---|---|---|---|
| | CA | OB | CB |

The next instruction OC enters the queue into Entry 3. When the next instruction OC (Entry 3) entries the queue 260 it is from the same thread as OB, but not from the same thread as instruction CA or CB. An in-thread itag comparison is first performed between instruction OC and instruction OB, and since instruction OC (Entry 3) is younger than instruction OB (Entry 1) it will not inherit any age values from the older instruction OB. Since instruction OC (Entry 3) is younger then instruction OB (Entry 1), Entry3_younger_Entry1=0, (location 3:1 (row:column)=0) and instruction OB (Entry 1) is older than instruction OC (Entry 3) so Entry1_older_Entry3=1 (location 1:3=1) as shown in Table 6.

TABLE 6

| | Comparison Entry | | | | |
|---|---|---|---|---|---|
| Entry | 0 | 1 | 2 | 3 | 4 |
| 0: CA | 1 | 1 | 1 | | 0 |
| 1: OB | 0 | 1 | 1 | 1 | 0 |
| 2: CB | 0 | 0 | 1 | | 0 |
| 3: OC | | 0 | | 1 | 0 |
| 4 | | | | | 1 |

Since instruction OC (Entry 3) is not from the same thread as instruction CA (Entry 0) or instruction CB (Entry 2) an itag comparison cannot be made to instructions CA or CB. Instead FIFO ordering is used where Entry 3 (instruction OC) is younger than Entry 0 (instruction CA) and younger then Entry 2 (instruction CB); Entry 3 younger_Entry0=0 (location 3:0=0) and Entry3_younger_Entry2=0 (location 3:2=0) as seen in Table 7. Also Entry 0 (instruction CA) is older than Entry 3 (instruction OC) and Entry 2 (Instruction CB) is older than Entry 3 (instruction OC) based upon FIFO ordering; Entry0_older_Entry3=1 (location 0:3=1), and Entry2_older_Entry3=1 (location 2:3=1) as shown in Table 7.

TABLE 7

| | Comparison Entry | | | | | Age |
|---|---|---|---|---|---|---|
| Entry | 0 | 1 | 2 | 3 | 4 | Cal. |
| 0: CA | 1 | 1 | 1 | 1 | 0 | 4 |
| 1: OB | 0 | 1 | 1 | 1 | 0 | 3 |
| 2: CB | 0 | 0 | 1 | 1 | 0 | 2 |
| 3: OC | 0 | 0 | 0 | 1 | 0 | 1 |
| 4 | | | | | | |

| Oldest | | | | Youngest |
|---|---|---|---|---|
| | CA | OB | CB | OC |

Next instruction OA enters the queue into Entry 4. Since instruction OA (Entry 4) is from the same thread as instruction OB (Entry 1) and instruction OC (Entry 3), an itag comparison is performed. Since instruction OA (Entry 4) is older than instruction OB (Entry 1) and instruction OC (Entry 3), instruction OA it will inherit age values from the next youngest instruction in the same thread as shown in Table 8 where instruction OB (Entry 1) is the next youngest instruction to instruction OA (Entry 4) so Entry 4=Entry 1.

The age values for the other entries already in the queue (Entry 0, Entry 1, Entry 2, and Entry 3) compared to the incoming instruction, i.e., Entry 4, also have to be set based upon the inherited values of Entry 4, i.e., Entry 4 comparisons already performed in the age matrix. For example, Entry 4 younger_Entry0 so Entry 0_older_Entry4=1 (location 0:4 (row: column)=1) as shown in Table 9. Similarly, Entry4_older_Entry1=1 so Entry1_younger_Entry4=0 (location 1:4=0); Entry4_older_Entry2=1 so Entry2_younger_Entry4=0 (location 2:4=0); and Entry4_older_Entry3=1 so Entry 3 younger_Entry 4=0 (location 3:4=0) as shown in Table 9.

TABLE 9

| | Comparison Entry | | | | | Age |
|---|---|---|---|---|---|---|
| Entry | 0 | 1 | 2 | 3 | 4 | Cal. |
| 0: CA | 1 | 1 | 1 | 1 | 1 | 5 |
| 1: OB | 0 | 1 | 1 | 1 | 0 | 3 |
| 2: CB | 0 | 0 | 1 | 1 | 0 | 2 |
| 3: OC | 0 | 0 | 0 | 1 | 0 | 1 |
| 4: OA | 0 | 1 | 1 | 1 | 1 | 4 |

| Oldest | | | | Youngest |
|---|---|---|---|---|
| CA | OA | OB | CB | OC |

In Table 9, the age calculation column indicates the relative age calculation where the more first values, i.e., 1's, that appear in a row corresponding to an instruction the older the instruction. So as seen in Table 9, instruction CA (Entry 0) has the most first values, i.e., number 1's, and is the oldest relative instruction.

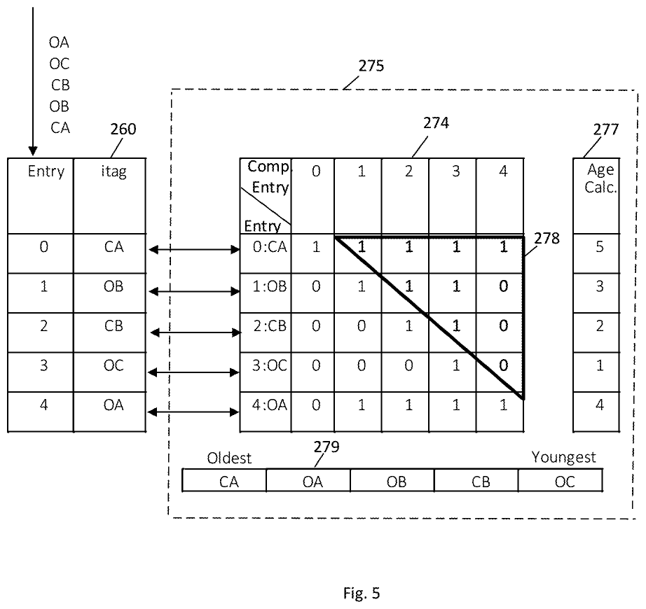

FIG. 5 is a diagram of queue 260 after instruction entries CA, OB, CB, OC, and OA enter the queue in that respective order. While the instructions, e.g., itags, entering the queue are shown as being placed in order in Entries 0-4, it will be appreciated that the instructions may be placed in any available entry location as they enter the queue. FIG. 5 shows age matrix 275 with age calculation column 277. The relative age of each entry is shown in FIG. 5 by counting the first values, i.e., 1's, for each instruction row. The oldest instruction is shown graphically in chart 279 in FIG. 5. While the full age matrix table 274 is shown in FIG. 5, only a triangle 278 of information may be stored as shown in FIG. 5 to conserve resources. The triangle of information 278 contains all the information to determine the relative age of the instruction in the queue. The process and logic exhibited in the above example and as shown in Tables 1-9 and FIG. 5 are useful to determine the relative age of instructions in a queue and can be utilized by the processor to determine an order of operation, which typically involves performing the operation of the oldest instruction next.

When a queue holds a super slice of instructions the age calculation gets more complicated as two incoming instructions can enter the queue at the same time. The two incoming instructions, e.g., itags, that enter the queue at the same time each need to be compared to existing entries, and need to be compared to each other. The process, techniques, rules, and logic applied to single-slice queue in an embodiment are applied to a queue that holds a super slice of instructions. In addition, for a super slice, when doing a comparison between two simultaneous incoming instructions that are from the same thread, do a thread compare between the two incoming instructions entries and determine the relative age between the two. When doing a comparison between two simultaneous incoming instructions from different threads, compare the relative age of the two instructions without considering the new instructions and confirm the relative age of the instructions. For example, as between two simultaneous incoming instructions, the instruction with the oldest age will be confirmed as the older instruction by setting that instruction as the older instruction (i.e., set the instruction that is older by using an “1”) and the younger instruction is confirmed as younger by setting that instruction as younger, (i.e., set the instruction that is younger by using a “0”). If the two simultaneous incoming instructions have the same age before an instruction comparison is performed, then one instruction can randomly be selected and assigned to be older than the other instruction. Another example will illustrate the process, rules, and logic applied to instructions dispatched to a queue that holds a super slice of instructions, and that may write two incoming instructions simultaneously to the queue, e.g., during the same cycle.

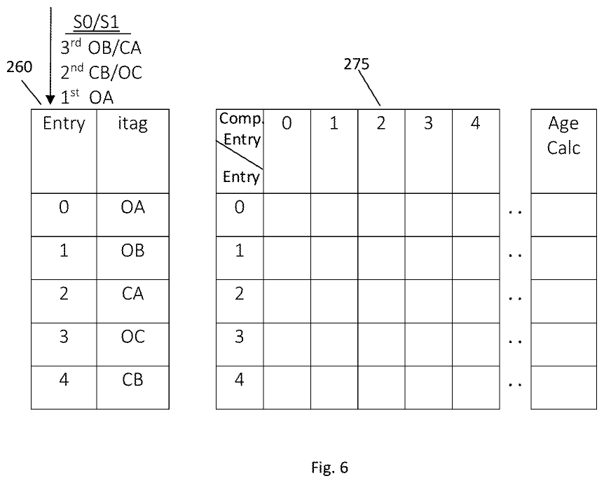

FIG. 6 illustrates an instruction queue 260 and corresponding age matrix 275. FIG. 6 illustrates two slices of instructions S0 and S1 of a super slice SS0, and threes cycles of instruction being dispatched to the queue 260. Instruction OA from slice S0 is dispatched to queue 260 in a first cycle; instructions CB from slice S0 and instruction OC from slice S1 are simultaneously dispatched to queue 260 in a second cycle; and instruction OB from slice S0 and instruction CA from slice S1 are both simultaneously dispatched to queue 260 in a third cycle.

Instruction OA enters the queue into Entry 0. When the instruction OA (Entry 0), itag OA, enters the queue 260, no other instruction is in the queue. The entry compared to itself is always set as a default 1, and since no other entries are in the queue there are no other instructions to make a comparison and so all the comparison entries are set to default, i.e. to “0”, as shown in Table 10.

TABLE 10

| | Comparison Entry | | | | |
|---|---|---|---|---|---|
| Entry | 0 | 1 | 2 | 3 | 4 |
| 0: 0A | 1 | 0 | 0 | 0 | 0 |
| 1 | | | | | |
| 2 | | | | | |
| 3 | | | | | |
| 4 | | | | | |

In the next cycle, both instructions OC and CB enter the queue 260, where instructions OC is placed into Entry 3 and instructions CB is placed into Entry 4. Since instruction OC (Entry 3) is from the same thread as instruction OA (Entry 0), an itag comparison is performed. Since instruction OC has an itag issued after instruction OA, instruction OC is younger than instruction OA, no inheritance is used, and a straight itag comparison sets instruction OC as younger; Entry 3 (OC)_younger_Entry 0 (OA)=0 (location 3:0=0). Likewise, instruction OA (Entry 0) is older than instruction OC (Entry 3) so Entry0_older_Entry3 =1 (location 0:3=1). Since instruction CB (Entry 4) is from a different thread than instruction OA (Entry 0), no itag comparison is performed. The comparison between the instruction CB and instruction OA from different threads relies on FIFO ordering and since instruction CB entered the queue 260 after instruction OA, instruction CB is considered younger and Entry 4 (CB)_younger_Entry 0 (OA)=0 (location 4:0=0) and Entry 0_older_Entry 4=1 (location 0:4=1) as illustrated in Table 11.

TABLE 11

| | Comparison Entry | | | | |
|---|---|---|---|---|---|
| Entry | 0 | 1 | 2 | 3 | 4 |
| 0: OA | 1 | 0 | 0 | 1 | 1 |
| 1 | | | | | |
| 2 | | | | | |
| 3: OC | 0 | | | 1 | |
| 4: CB | 0 | | | | 1 |

After comparing the two simultaneous in-coming instructions to the instruction(s) in the queue, the two simultaneous in-coming instructions OC and CB are compared to each other. Since instructions OC and CB are from different threads and are entering the queue at the same time, e.g., same cycle, there is no way to determine which thread is older. Since an itag comparison cannot be utilized, and FIFO cannot be utilized between instructions OC and CB since they entered the queue at the same time, and since the instructions have the same age in comparison to the only instruction OA in the queue, one of instructions OC and CB are picked to be older and assigned a “1” in the age matrix 275. As shown in Table 12, instruction CB (Entry 4) from slice S0 is picked to be older than instruction OC (Entry 3) so Entry 4_older_Entry 3=1 (location 4:3=1; and location 3:4=0). Since no instructions have entered the queue in location entries 1 and 2, the comparison of instructions in Entries 3 and 4 to entries 1 and 2 are set to 0 in Table 12.

TABLE 12

| | Comparison Entry | | | | |
|---|---|---|---|---|---|
| Entry | 0 | 1 | 2 | 3 | 4 |
| 0: OA | 1 | 0 | 0 | 1 | 1 |
| 1 | | 1 | | | |
| 2 | | | 1 | | |
| 3: OC | 0 | 0 | 0 | 1 | 0 |
| 4: CB | 0 | 0 | 0 | 1 | 1 |

During the next cycle, instructions OB from slice S0 and instruction CA from slice 51 enter queue 260. Instruction OB enters the queue 260 into Entry 1 while instruction CA enters the queue into Entry 2. Turning first to the age calculation of instruction OB (Entry 1), instruction OB is from the same thread of instructions as instructions OA and OC so an itag comparison is performed. Instruction OB is younger than (dispatched after) instruction OA and older than (dispatched before) instruction OC, so instruction OB (Entry 1) will inherit the age from younger instruction OC (Entry 3) and that inheritance propagates back to entries 0, 3 and 4, which corresponds to instructions already in the queue 260 when instruction OB (Entry 1) enters the queue. Therefore, Entry 1 (instruction OB) has the same “1” or “0” assigned in age matrix 275 for Entries “0”, “3”, and “4” as Entry 3 (instruction OC) has for Entries “0”, “3”, and “4” as shown in Table 13.

The itag comparison of instruction OB to instructions OA and OC confirms that the comparison entries for instruction OB for entries 0 and 3 are correct; Entry 1 (OB)_younger_Entry 0 (OA)=0 (location 1:0=0) and Entry 1 (OB)_older_Entry 3 (OC) =1 (location 1:3=1). Since instruction CB (Entry 4) is from a different thread then instruction OB (Entry 1) it is important that instruction OB (Entry 1) inherits the instruction age comparison from younger instruction OC (Entry 3) compared to instruction CB (Entry 4). Since the age comparison of instruction OC (Entry 3) younger instruction CB (Entry 4)=0, instruction OB (Entry 1) younger instruction CB (Entry 4) =0 (location 1:4=0).

Turning to the age comparisons for instruction CA, instruction CA (Entry 2) is from the same thread as instruction CB (Entry 4) and is compared to instruction CB (Entry 4) from the same thread. In other words, an in-thread itag comparison is first performed. Since instruction CA is older than instruction CB, instruction CA inherits the age from younger instruction CB (Entry 4), so instruction CA (Entry 2) inherits the ages (0s and 1s) from instruction CB (Entry 4). So Entry 2 (instruction CA) inherits the ages from the age instruction comparison from Entry 4 (Instruction CB) for entries that were already in the queue, i.e., Entries 0, 3 and 4—as shown in Table 14 (Entry 4 younger_Entry 0=0 so Entry 2 younger_Entry 0=0 and location 2:0=0; Entry 4_older_Entry 3 =1 so Entry 2_older_Entry 3=1 and location 2:3=1; Entry 2_older_Entry 4=1 (instruction CA issued before instruction CB) so location 2:4=1). Also, since as a result of instruction CA (Entry 2) inheriting the age of instruction CB (Entry 4), Entry 2(CA) is older than Entry 3(OC) so Entry 3 (OC)_younger_Entry 2(CA) =0 (location 3:2=0); and Entry 2(CA) is older than Entry 4(CB) so Entry 4 is younger than Entry2 =0 (Entry 4 younger_Entry 2=0, location 4:2=0) as shown in Table 14. Also note that Entry 2 compared to position 2 is always set to 1 (N:N=1). In addition, note that no comparison is performed between instruction OB (Entry 1) and instruction CA (Entry 2) yet, as these instructions entered the queue 260 at the same time.

Next an age comparison is performed between the two simultaneous in-coming instructions OB (Entry 1) and CA (Entry 2). The two simultaneous in-coming instructions OB and CA are from different threads so no direct comparison, e.g., itag comparison, is possible. Also, since the instructions entered the queue at the same time no FIFO calculation is possible. In this situation, the relative age of the two instructions will be confirmed and entered in the age matrix. Thus, as between instruction OB (Entry 1) and instruction CA (Entry 2) we take the calculated age, after inheritance, as shown in Table 15 and can use that relative age to set the final two ages in the age matrix. A Hamming Weight Comparison may be used for the calculation.

TABLE 15

| | Comparison Entry | | | | | Age |
|---|---|---|---|---|---|---|
| Entry | 0 | 1 | 2 | 3 | 4 | Cal. |
| 0: OA | | | | | | |
| 1: OB | 0 | 1 | | 1 | 0 | 2 |
| 2: CA | 0 | | 1 | 1 | 1 | 3 |
| 3: OC | | | | | | |
| 4: CB | | | | | | |

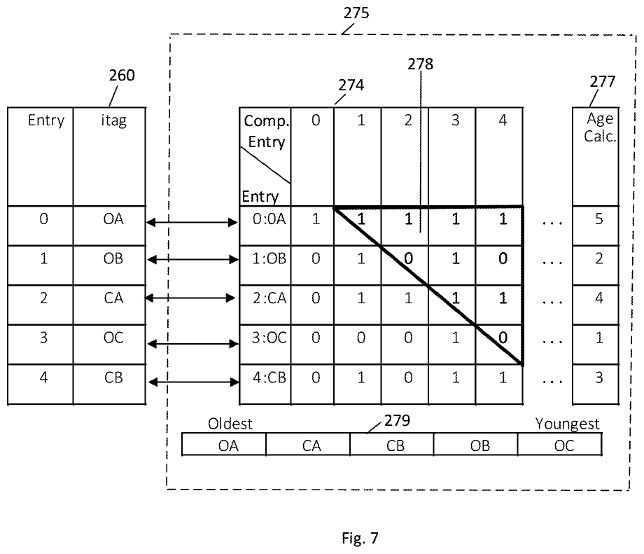

As seen in Table 15, instruction CA (Entry 2) is determined to be older than instruction OB (Entry 1) as shown in the Age Calculation box in Table 15 so Entry CA (Entry 2) older_instruction OB (Entry 1) =1 (location 2:1=1 and location 1:2=0) and the age matrix for instruction OB (Entry 1) and CA (Entry 2) are set as shown in Table 16 and FIG. 7.

TABLE 16

| | Comparison Entry | | | | | Age |
|---|---|---|---|---|---|---|
| Entry | 0 | 1 | 2 | 3 | 4 | Cal. |
| 0: OA | 1 | 1 | 1 | 1 | 1 | 5 |
| 1: OB | 0 | 1 | 0 | 1 | 0 | 2 |
| 2: CA | 0 | 1 | 1 | 1 | 1 | 4 |
| 3: OC | 0 | 0 | 0 | 1 | 0 | 1 |
| 4: CB | 0 | 1 | 0 | 1 | 1 | 3 |

| Oldest | | | | Youngest |
|---|---|---|---|---|
| OA | CA | CB | OB | OC |

As illustrated in FIG. 7, the number of is in the row corresponding to Entry 0, instruction CA, is five (5); the row corresponding to Entry 1, instruction OB, is two (2); the row corresponding to Entry 2, instruction CA, is four (4); the row corresponding to Entry 3, instruction OC, is one (1); and the row corresponding to Entry 4, instruction CB, is three (3) as shown in age calculation table 277. The instruction with the highest number is the oldest instruction and thus the queue 260 in FIG. 7 has an instruction age of oldest to youngest as shown in graphic 279 and Table 16 where the relative age of the instructions from oldest to youngest is CA, OA, OB, CB and OC. As with FIG. 5 and Table 9, only a triangle of information 278 in an embodiment is saved and is sufficient to determine the relative age of the instructions in the queue.

FIGS. 8-9 are exemplary flowcharts in accordance with one or more embodiments illustrating and describing one or more methods, methodology, process, rules, and logic for determining the relative age of instructions in a queue in accordance with one or more embodiments of the present disclosure. While the age determination methods 800 and 900 are described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 8 or FIG. 9, but the processes in those flowchart blocks may be integrated and/or one or more steps may be performed together, simultaneously, or the steps may be performed in the order disclosed or in an alternative order.

The process, methodology, rules and/or logic 800 for determining the relative age of an instruction in a queue is illustrated for an embodiment by the flow diagram in FIG. 8. The process, methodology, rules and/or logic 800 are for multiple instructions for multiple threads dispatched in a single processor/execution slice where two instructions are not written simultaneously, e.g., in the same cycle, to the queue.

At 810, an instruction is written to a queue. The queue may be an issue queue, a reorder queue, a load or store queue in a load store unit (LSU), or other queue for holding one or more instructions. At 820, the position in the matrix corresponding to the entry, e.g., the diagonal in FIGS. 4-5, is to set to 1. That is location 1:1 (row:column), location 2:2 (row:column), location 3:3 (row:column), location N:N (row:column), etc. are set to 1 in the age matrix.

At 830, in an embodiment, each comparison entry in the age matrix for the incoming instruction for which there is no instruction to compare to is set to 0 as a default value. At 840, a determination is made whether or not the incoming instruction is from the same thread as any instruction already in the queue. If the incoming instruction is the same thread as one or more instructions already in the queue (if 840: Yes), then an in-thread, itag, comparison is performed at 850 between the incoming in-thread and the thread instructions already in the queue. If the incoming instruction is from a thread that has no instructions in the queue (If 840: No), then the process/methodology proceeds to 870 in the flowchart of FIG. 8.

When performing an in-thread comparison between the incoming instruction, and instructions already in the queue, in an embodiment, if the incoming instruction is younger than an in-thread instruction in the queue, an itag comparison is performed between the incoming instruction and the older in-thread instruction already in the queue, and the incoming younger instruction is assigned a 0. If on the other hand, the incoming instruction is older than one or more in-thread instructions already in the queue, at 860, the incoming instruction inherits (is assigned) the age comparisons from the next younger in-thread instruction in the queue for all the comparisons already performed for that younger in-thread instruction in the queue. An example is shown in Tables 8, 13, and 14 and their associated discussion. The incoming instruction inherits the age values (e.g., the 1s) from the next younger instruction.

After the in-thread comparison is performed, the process in an embodiment continues with the out of thread comparison being performed between the incoming instruction and the out of thread instructions already in the queue. At 870, in an embodiment, the methodology, process, rules, and logic for the age matrix calculations includes a FIFO comparison for out of thread calculations, where the incoming instruction is set to be younger than the out of thread instructions already in the queue. At 880, the age calculations are performed where the entry row values are added and the relative ages of the instructions are determined where the oldest instruction has the highest value and the youngest instruction has the youngest value.

Process, methodology, rules, and/or logic 900 for determining the relative age of an instruction in a queue is illustrated for an embodiment by the flow diagram in FIG. 9. The process, methodology, rules, and/or logic 900 in FIG. 9 are for multiple instructions for multiple threads dispatched to a queue that holds instructions for a super slice in a processor and/or execution unit where two instructions may be written to the queue simultaneously, e.g., in the same cycle. The methodology, process, rules, and/or logic 900 as applied to a queue written by a single slice as illustrated in FIG. 8, in an embodiment, still apply to the process of FIG. 9. In an embodiment, operations 810, 820, 830, 840, 860, 870, and 880 apply to the process, methodology, and technique 900 of determining the relative age of an instruction written to a queue in a super slice of a processor, preferably where a single instruction is dispatched to the queue at a time.

In FIG. 9, according to the methodology, process, and/or technique 900, an instruction enters the queue at 905. The queue may be an issue queue, a reorder queue, a load and/or store queue in an execution unit, or any other queue that holds or stores instructions in a processor. In an embodiment at 910, the comparison entry for the incoming instruction compared to itself is set to 1 in the age matrix. That is locations N:N are set to “1”. Comparison entries for the incoming instruction where there is no instruction in the queue for comparison are set to “0” at 915. At 920, a determination is made as to whether a single instruction or whether two or more simultaneous incoming instructions entered the queue at the same time, e.g., during the same cycle. If only one instruction entered the queue during the cycle (920:Yes), then the methodology, steps, processes, and/or techniques of process 800 described in association with FIG. 8 are performed to determine the relative age of the incoming instruction.

If multiple incoming instructions are written to the queue at the same time (920:No), then it is determined at 930 whether one of the simultaneous incoming instructions is from the same thread as one of the instructions already in the queue. If one of the simultaneous incoming instructions is from the same thread as one of the instructions already within the queue (930:Yes), then in an embodiment, at 940, an in-thread instruction, itag, comparison is performed. If the incoming instruction is different than any thread of any instructions already in the queue (930:No), then the process and/or methodology moves to the operations at 950. At 940, when performing the operations for an in-thread instruction, itag, comparison, the system and/or methodology in an embodiment at 945 may perform the operations of 860 as described in association with FIG. 8. After in-thread comparisons are performed, in an embodiment, out of thread comparisons are performed at 950. In an embodiment at 950, a FIFO comparison is performed for the simultaneous incoming thread that is from a different thread than the instructions already in the queue. Accordingly, for instructions already in the queue but from a different thread, the incoming instruction is younger than the instruction already in the queue and is set to 0.

After comparing each of the two simultaneous incoming instructions individually to the instructions already in the queue, at 960 a relative age comparison is made between the two simultaneous incoming instructions entering the queue. In a first aspect, if the two simultaneous instructions are from the same thread, an itag comparison is performed and the instructions are assigned the appropriate values in the age matrix. If the two simultaneous instructions are from a different thread, then as part of the system and age methodology calculation 900, in an embodiment, at 965, the relative ages of the incoming instructions is confirmed. In other words, after the operations of 940, 945, and 950, where age inheritance and FIFO rules are applied as applicable, the two incoming instructions from different threads are compared and if one of the incoming instructions is calculated to be older than the other instruction by adding up the values in the entry row, then at 965 the incoming instruction calculated to be older is confirmed. As an illustration, if Entry A is calculated to be older than Entry B that entered the queue at the same time, then Entry A_older_Entry B=1 (location A:B=1) and Entry B younger_Entry A=0. (location B:A=0). This operation was illustrated in example two when discussing incoming instructions OB and CA and the associated discussion of Tables 15 and 16. In an embodiment, at 970, if the two simultaneous incoming instructions have the same calculated age, then either one of the simultaneous instructions can be set (assigned) as older and a 1 can be assigned in the age matrix for the randomly assigned older instruction.

At 975, in an embodiment, the values in the age matrix are calculated, e.g., the values in the row for the entry are added up and the relative age of the instructions is determined. For example, the 1s and 0s in the row are added and the row or entry with the highest value is deemed the relative oldest instruction while the row/entry with the lowest value is deemed the youngest.

Age data may be a particularly important feature during issue of instructions from queues, for example, queue 260 within IQ 250, or queues within Execution Units 280. When determining eligibility for instruction issue, processor 200 may determine that the oldest instruction that meets all other dependency characteristics during any particular clock cycle is most eligible for issue. In other words, the oldest instruction with no pending dependency factors is “issue ready” during the next processor cycle. In one embodiment, age matrix 275 may include a ready bit (not shown) that corresponds to each queue entry, such as the five positions (Entry 0-Entry 4) of age matrix 275. In this case, queues may employ ready bit data to determine a particular instruction's issue readiness. An issue ready instruction may require a valid ready bit and an age data of age matrix 275 corresponding to the oldest instruction. As processor 200 resources, such as execution units 280 are available, issue ready instructions issue from IQ 250 or other queues, not shown. Execution unit 280 executes the issue ready instructions to provide instruction processing results to processor 200. Instruction processing results may affect other instruction dependency data of instructions within IQ 250 or other issue queues, not shown, in processor 200.

In one embodiment of the disclosed instruction age tracking method, age matrix 275 may contain multiple latches, where one latch may be provided for each location (row:column) in the age matrix. Each latch maintains a binary data storage of one portion of multiple binary data representing the relative age of the instruction in the IDS or queue 260. Age matrix 275 may modify latch 330 data by employing logic controllers. During the dispatch of any particular instruction to a queue, age matrix 275 may modify the contents of the latches to reflect changing age relationship characteristics of each instruction in the queue.

The foregoing discloses methodologies wherein a processor may employ queues of instructions. An age matrix of the queue may manage the relative age of instructions that reside within the queue. During instruction dispatch to a queue, the age matrix in an embodiment updates binary age data in an array of latches or other memory cells to reflect the relative aging of out-of-order instruction issues. The age matrix may update a particular group of latches that reflect the changing age data and does not update clock latches that do not require change. In this manner, processor 200 may consume less power through a reduction in clocking power during dispatch of instructions into queues.

While the illustrative embodiments described above are preferably implemented in hardware, such as in units and circuitry of a processor, various aspects of the illustrative embodiments may be implemented in software as well. For example, it will be understood that each block of the flowchart illustrations in FIGS. 8-9, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions, and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

In an embodiment the disclosure provides a method of determining the relative age of instructions in a queue in a processor. The method in an embodiment includes providing one or more incoming instructions to the queue; setting comparison entry in age matrix to a first value for the instruction incoming to the queue; setting comparison entry in age matrix to a second value for all instruction entries where no instruction is present in the queue; determining whether the incoming instruction is from same thread as any instruction in the queue; for instructions in the same thread as the incoming instruction perform an in-thread comparison and assign the first value in the age matrix for older instructions and the second value in the age matrix for younger instructions; perform FIFO comparison between incoming instruction and out of thread instructions assigning the first value in the age matrix for the older instruction and the second value in the age matrix for the younger instruction; and calculate values in the age matrix for queue entries and determine relative age of instructions based upon values entered in the age matrix. In one aspect, the first value is a binary 1 and the second value is a binary 0, and the relative age of the instructions is determined by calculating the binary values in the age matrix where the oldest instruction has the highest calculated value and the youngest instruction has the lowest calculated value in the age matrix.

In an embodiment, the age comparisons between the incoming instruction with the in-thread instructions in the queue are performed before the comparison between the incoming instruction and the out of thread instructions in the queue. For the age comparison between the incoming instruction and instructions in the queue within the same thread where the incoming instruction is younger than all other instructions already in the queue, a comparison is performed using itags associated with the instructions and the incoming instruction is assigned a second value in the age matrix for all those in-thread instruction comparisons. For the age comparison between the incoming instruction and instructions in the queue with the same thread where the instruction is older than any instruction already in the queue, the incoming instruction inherits the relative age comparison values for the next younger in-thread instruction for all instructions already in the queue. If multiple instructions enter the queue at the same time, perform age calculations by comparing each simultaneous incoming instruction independently to instructions already in the queue, and then perform age calculations between the simultaneous incoming instructions. Performing the age calculation between the simultaneous instructions entering the queue in an aspect includes assigning values in the age matrix that confirms the relative age of the simultaneous incoming instructions and if in response to performing an age comparison between the two simultaneous incoming instructions there is no difference in the inherited ages, one of the simultaneous incoming instructions is assigned the value in the age matrix corresponding to an older instruction.

In an embodiment, an information handling system for processing information is disclosed. The information handling system includes at least one processor; at least one queue associated with the processor and having a plurality of entries positions for holding instructions; and at least one age matrix associated with the queue for determining the relative age of the instructions held within the queue, wherein the relative age between instructions within the queue and an instruction incoming into the queue is determined by first performing an in-thread comparison between the incoming instruction and any instructions in the queue, and thereafter performing an out of thread comparison between the incoming instruction and any instructions in the queue. In an aspect, the processor is designed and configured to determine if the incoming instruction is older than any in-thread instruction already in the queue, and if the incoming instruction is older than any in-thread instruction already in the queue, assign in the age matrix calculations for the older in-thread instruction the age of the next youngest in-thread instruction already in the queue. In another aspect, the processor is designed and configured to determine if multiple instructions are entering the queue at the same time, and if multiple instructions are entering the queue at the same time, perform age comparison calculations first by comparing each simultaneous incoming instruction independently to instructions already in the queue, and then perform age calculations between the simultaneous incoming instructions.

In another embodiment an information handling system for processing information is disclosed that includes at least one processor; at least one queue associated with the processor and having a plurality of entries positions for holding instructions; at least one age matrix associated with the queue for determining the relative age of the instructions held within the queue; one or more computer readable non-transitory storage media; and programming instructions stored on the one or more computer readable non-transitory storage media for execution by the at least one processor, the programming instructions including programing instructions to determine the relative age between instructions within the queue and an instruction incoming into the queue including programing instructions to first perform an in-thread comparison between the incoming instruction and any instructions in the queue, and thereafter perform an out of thread comparison between the incoming instruction and any instructions in the queue. The system further including programming instructions to determine if the incoming instruction is older than any in-thread instruction in the queue, and programming instructions so that if the incoming instruction is older than any in-thread instruction already in the queue, assign in the age matrix calculations for the older in-thread instruction the age of the next youngest in-thread instruction already in the queue. The system further including programming instructions to determine if multiple instructions are entering the queue at the same time and programming instructions so that if multiple instructions are entering the queue at the same time, perform age comparison calculations first by comparing each simultaneous incoming instruction independently to instructions already in the queue, and then perform age calculations between the simultaneous incoming instructions. The system in an aspect also includes program instructions such that performing the age calculation between the simultaneous incoming instructions entering the queue includes assigning values in the age matrix that confirms the relative age of the simultaneous incoming out of thread instructions that includes taking into account the ages inherited by any of the simultaneous incoming instructions that are older than any in-thread instructions already within the queue.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a field programmable gate array (FPGA), etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments and examples were chosen and described in order to best explain the principles of the invention and the practical application, and to enable others of ordinary skill in the art to understand the invention for various embodiments with various modifications as are suited to the particular use contemplated.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of determining a relative age of one or more instructions in a queue in a processor, the method comprising:
providing one or more incoming instructions to the queue;
setting comparison entry in age matrix to a first value for the incoming instruction to the queue;
setting comparison entry in an age matrix to a second value for an instruction entry containing no instruction in the queue;
determining whether the incoming instruction is from a same thread as any of the one or more instructions in the queue;
for an instruction in the same thread as the incoming instruction, performing an in-thread comparison and assigning the first value in the age matrix for an older instruction and the second value in the age matrix for a younger instruction;
performing a FIFO comparison between the incoming instruction and an out of thread instruction already in the queue and assigning the first value in age matrix for the older instruction and the second value in the age matrix for the younger instruction; and
calculating values in the age matrix for queue entries to determine a relative age of instructions based upon a plurality of values entered in the age matrix.

2. The method of claim 1, wherein the first value is a binary 1 and the second value is a binary 0, and the relative age of the instructions is determined by calculating the binary values in the age matrix where the oldest instruction has the highest calculated value and the youngest instruction has the lowest calculated value in the age matrix.

3. The method of claim 1, wherein the age comparisons between the incoming instruction with the in-thread instructions in the queue is performed before the comparison between the incoming instruction and the out of thread instructions in the queue.

4. The method of claim 3, wherein for the age comparison between the incoming instruction and instructions in the queue within the same thread where the incoming instruction is younger than all other instructions already in the queue, performing a comparison using itags associated with the instructions and assigning the incoming instruction a second value in the age matrix for all those in-thread instruction comparisons.

5. The method of claim 1, wherein for the age comparison between the incoming instruction and instructions in the queue with the same thread where the instruction is older than any instruction already in the queue, the incoming instruction inherits the relative age comparison values for the next younger in-thread instruction for all instructions already in the queue.

6. The method of claim 1, further comprising determining whether one instruction or multiple instructions entered the queue during the same cycle, and if multiple instructions entered the queue at the same time performing age calculations by comparing each simultaneous incoming instruction independently to instructions already in the queue, and then performing age calculations between the simultaneous incoming instructions.

7. The method of claim 6, further comprising performing an in-thread comparison between at least one of the simultaneous incoming threads and instructions already in the queue.

8. The method of claim 7, further comprising performing the operations of claim 4 or 5 for the age comparison between the simultaneous incoming instructions and in-thread instructions already within the queue.

9. The method of claim 8, further comprising, after the operations of claim 8, performing a FIFO comparison independently between each simultaneous in-coming instruction and the instructions already in the queue.

10. The method of claim 6, wherein performing the age calculation between the simultaneous instructions entering the queue from different threads includes assigning values in the age matrix that confirms the relative age of the simultaneous incoming instructions.

11. The method of claim 10, wherein confirming the relative age of the simultaneous incoming instructions includes taking into account the ages inherited by any of the simultaneous incoming instructions that are older than any in-thread instructions already within the queue.

12. The method of claim 10, wherein if in response to performing an age comparison between the two simultaneous incoming instructions there is no difference in the inherited ages, assigning one of the simultaneous incoming instructions the value in the age matrix corresponding to an older instruction.

13. The method of claim 6, wherein two instructions simultaneously enter the queue during the same cycle from two different execution slices.

14. The method of claim 1, further comprising saving only a triangle of information from the age matrix for determining the relative ages of instructions in the queue.

15. The method of claim 1 wherein the queue is in at least one of a group consisting of an issue queue, an execution unit, and combinations thereof.

16. An information handling system for processing information, the information handling system comprising:
at least one processor;
at least one queue associated with the processor having a plurality of entry positions for holding instructions; and
at least one age matrix associated with the at least one queue for determining a relative age of the instructions held within the queue,
wherein the relative age between instructions within the queue and an incoming instruction into the queue is determined by performing an in-thread comparison between the incoming instruction and any of a plurality of instructions in the queue, and thereafter performing an out of thread comparison between the incoming instruction and any one of the plurality of instructions in the queue.

17. The system of claim 16, wherein the processor is designed and configured to determine if the incoming instruction is older than any in-thread instruction already in the queue, and if the incoming instruction is older than any in-thread instruction already in the queue, then the processor is designed and configured to assigns in the age matrix calculations for the older in-thread instruction, the age of the next youngest in-thread instruction already in the queue.

18. The system of claim 17, wherein the processor is designed and configured to determine if multiple instructions are entering the queue at the same time, and if multiple instructions are entering the queue at the same time, then the processor is designed and configured to perform age comparison calculations first by comparing each simultaneous incoming instruction independently to instructions already in the queue, and then perform age calculations between the simultaneous incoming instructions.

19. The system of claim 18, wherein the processor is designed and configured such that performing the age calculation between the simultaneous incoming instructions entering the queue includes assigning values in the age matrix that confirms the relative age of the simultaneous incoming instructions that includes taking into account the ages inherited by any of the simultaneous incoming instructions that are older than any in-thread instructions already within the queue.

20. An information handling system for processing information, the information handling system comprising:
at least one processor;
at least one queue associated with the processor and having a plurality of entry positions for holding instructions;
at least one age matrix associated with the queue for determining a relative age of an instruction held within the queue;
one or more computer readable non-transitory storage media; and
programming instructions stored on the one or more computer readable non-transitory storage media for execution by the at least one processor, the programming instructions comprising:
programing instructions to determine a relative age between instructions within the queue and an incoming instruction into the queue including programing instructions to perform an in-thread comparison between the incoming instruction and any one of the plurality of instructions in the queue, and thereafter perform an out of thread comparison between the incoming instruction and any one of the plurality of instructions in the queue.
